(19) United States
(12) Patent Application Publication
(10) Pub. No.: US 2016/0026699 A1
(43) Pub. Date: Jan. 28, 2016

(54) Method for Synchronization of UGC Master and Backup and System Thereof, and Computer Storage Medium

(71) Applicant: TENCENT TECHNOLOGY (SHENZHEN) COMPANY LIMITED, Guangdong (CN)

(72) Inventors: Ming Tian, Guangdong (CN); Li Liu, Guangdong (CN)

(73) Assignee: Tencent Technology (Shenzhen) Company Limited, Guangdong (CN)

(21) Appl. No.: 14/415,372

(22) PCT Filed: Jul. 25, 2013
(86) PCT No.: PCT/CN13/80081

§ 371 Date: Jan. 16, 2015

(30) Foreign Application Priority Data
Jul. 25, 2012 (CN) 201210261533.6

(51) Int. Cl. G06F 17/30

(52) U.S. Cl. CPC G06F 17/30575; G06F 17/30371; G06F 17/30348

(57) ABSTRACT

Provided are a method for synchronization of UGC master and backup data and a system there of, and a computer storage medium. The method includes the steps of: determining, when performing data synchronization of a master storage site and a backup site of UGC data, whether a version identifier stored satisfies a predetermined full synchronization condition, the version identifier corresponding to UGC data update of each user identifier in the master storage site; acquiring, when it is determined that the version identifier stored satisfies the predetermined full synchronization condition, from the master storage site full amount of UGC data corresponding to the user identifier, and synchronizing the UGC data to the backup site; otherwise, acquiring from the master storage site the UGC update data corresponding to the user identifier, and synchronizing the UGC update data to the backup site. By the method and system, synchronization consistency of the UGC master and backup data is realized, and the synchronization data will not occupy excessive communication resources; thereby the influence of UGC data expansion on the synchronization efficiency is relatively low.

### CROSS REFERENCE TO RELATED APPLICATIONS

This application is a National Stage of International Application PCT/CN2013/080081, filed on Jul. 25, 2013, which claims the benefit of Chinese Patent Application No. 2012102615336, filed on Jul. 25, 2012. The entireties of both applications are hereby incorporated by reference.

### FIELD

The present disclosure relates generally to the field of Internet technology, and more particularly, to a method and system for synchronization of UGC master and backup data.

### BACKGROUND

UGC (User generated content) has provided a new way for using the Internet, by which the application of Internet has changed from the downloading by user to both downloading and uploading data by the user. The application of UGC includes, but not limited to, community network, video sharing, and micro-blog, etc. With the development of global Internet business, UGC business is gradually raising, which causes widespread concern in the industry.

The storage of data generated by user is one of the key technologies involved in UGC applications. To improve the user experience, ensure the system stability and disaster-resisting capability (e.g., in cases of power off of Internet data center, earthquake and other accidents), the way of redundant hot standby is generally used in storing UGC data. That is, data is stored in multiple copies, such as in multiple IDCs (Internet data centers) respectively, or even in IDCs of different cities. One of the copies is master site data stored in a master storage site, which is the only entrance to write the UGC data. The other copies are backup data stored in backup sites, which receive the synchronization of the master site data. By the synchronization system, consistency is maintained in real-time among the multiple copies of data.

Due to the characteristic of data expansion of applications of UGC type—that is, the amount of data generated by the user will be more and more over time, such as the data generated by users when publishing micro-blogs being increasing as the amount of micro-blog increases—the amount of data to be synchronized between the master storage site and a backup site will become more and more, occupying more and more communication bandwidth resources. Thus, due to the expansion characteristic of UGC data, the requirement of high real-time consistency between the master site data and backup data has become a problem.

As shown in FIG. 1, a method for synchronization of UGC master and backup data usually achieves data consistency by periodical synchronization of full amount. When the UGC data of a user is modified, an update identifier ‘local seq’ of a user group ‘unit’ (a set consisted of a plurality of user identifier ‘uin’) corresponding to the master storage site ‘Master’ is added by 1. A synchronization process ‘syncd’ periodically check the difference between the ‘local seq’ and the update identifier ‘peer seq’ of the backup site. When it is determined that ‘local seq’>‘peer seq’, the ‘uin’ where data update occurs is taken out from data update log tinlog' of the master storage site according to the ‘peer seq’, and the corresponding full amount data of UGC data of the ‘uin’ is also taken out and sent to a backup site ‘Slave’. The backup site ‘Slave’ receives the full amount of UGC data, stores it to the corresponding uin, and updates the update identifier ‘local seq’ of local user group ‘unit’, so as to maintain data consistency.

When the amount of data to be synchronized between the master site and the backup site is substantially stable and not too much, the above synchronization method can advantageously ensure the data consistency. However, due to the obvious expansion characteristics of data in UGC applications, the amount of a user's UGC data will become larger over time. For example, in a micro-blog application, the amount of micro-blogs published by a user may reach hundreds of thousands, and total user index data may also reach tens of megabytes. Consequently, when using the above synchronization method, the full amount of UGC data corresponding to the user's identifier is synchronized to the backup site each time the user publishes a micro-blog or deletes a micro-blog. Thus, with the amount of data to be synchronized getting larger, the efficiency and real-time performance of the synchronization will be greatly reduced. Meanwhile, the common solutions mostly rely on dedicated bandwidths set up for synchronization, but the resource of synchronization line is limited, and especially costly in case of synchronization line cross cities.

Therefore, heretofore unaddressed needs exist in the art to address the aforementioned deficiencies and inadequacies.

### BRIEF SUMMARY OF THE DISCLOSURE

In view of the above, it is an object of the present disclosure to provide a method for synchronization of UGC master and backup data, which can maintain the consistency of the UGC master and backup data, and the synchronization data will not occupy excessive communication resources. In addition, a system for synchronization of UGC master and backup data and a computer storage medium thereof are provided.

According to an aspect of the present disclosure, a method for synchronization of UGC master and backup data includes:

determining, when performing data synchronization of a master storage site and a backup site of UGC data, whether a version identifier stored satisfies a predetermined full synchronization condition, the version identifier corresponding to update of UGC data of each user identifier in the master storage site;

acquiring, when it is determined that the version identifier stored satisfies the predetermined full synchronization condition, from the master storage site full amount of UGC data corresponding to the user identifier, and synchronizing the UGC data to the backup site;

otherwise, acquiring from the master storage site the UGC update data corresponding to the user identifier, and synchronizing the UGC update data to the backup site.

According to another aspect of the present disclosure, a system for synchronization of UGC master and backup data is executed in a computer system. The computer system includes a processor and a system memory, the system memory including:

an update version identifier module, configured to store a version identifier of UGC data update corresponding to each user identifier in a master storage site;

a determination module, configured to determine, when performing data synchronization of the master storage site and backup site of UGC data, whether the version identifier satisfies a predetermined full synchronization condition, and

a data synchronization module, configured to acquire from the master storage site full amount of UGC data corresponding to the user identifier and synchronize the full amount of UGC data to the backup site when the version identifier satisfies the predetermined full synchronization condition, and to acquire UGC update data corresponding to the user identifier from the master storage site and synchronize the UGC update data to the backup site when the version identifier does not satisfy the predetermined full synchronization condition.

According to another further aspect of the present disclosure, a non-transitory computer-readable storage medium storing computer-executable instructions which, when executed by one or more computer processors, causes the one or more computer processors to perform a method of image browsing. The method includes the steps of:

determining, when data synchronization of a master storage site and a backup site of UGC data is executed, whether a version identifier stored satisfies a predetermined full synchronization condition, the version identifier being that of UGC data update corresponding to each user identifier in the master storage site;

acquiring, when it is determined that the version identifier stored satisfies the predetermined full synchronization condition, from the master storage site full amount of UGC data corresponding to the user identifier, and synchronizing the UGC data to the backup site;

otherwise, acquiring from the master storage site the UGC update data corresponding to the user identifier, and synchronizing the UGC update data to the backup site.

With the method for the synchronization of UGC master and backup data and the system thereof of the present disclosure, by storing a version identifier of UGC data update corresponding to each user identifier stored in the master storage site and presetting full synchronization condition, the full synchronization will be executed only when the version identifier satisfies the predetermined full synchronization condition. This ensures the data consistency between the UGC master site and backup site. Otherwise, incremental synchronization is performed so as to prevent the synchronization data from occupying excessive communication bandwidth resources. Thus, consistency of the expansive data of UGC application can be maintained in real time even in case of narrowband.

### BRIEF DESCRIPTION OF THE DRAWINGS

FIG. 1 is a schematic diagram illustrating a method for synchronization of UGC master and backup data in prior art.

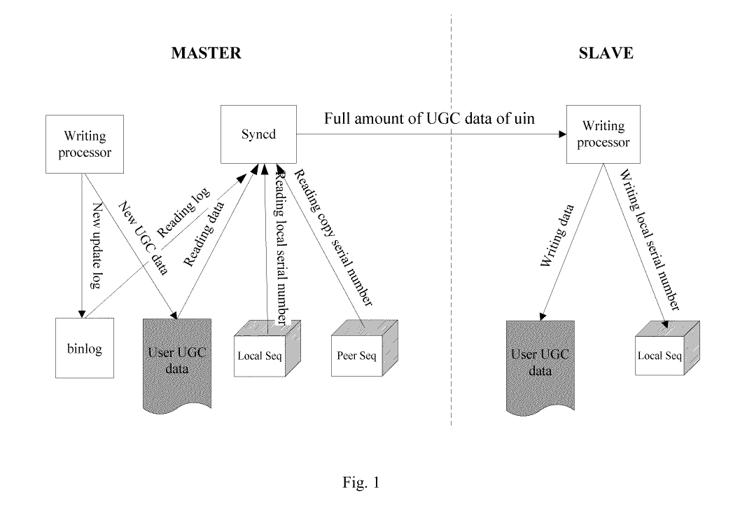

FIG. 2 is a flowchart illustrating a first example of a method for synchronization of UGC master and backup data according to one embodiment of the present disclosure.

FIG. 3 is a flowchart illustrating a second example of a method for synchronization of UGC master and backup data according to one embodiment of the present disclosure.

FIG. 4 is a schematic diagram illustrating an application of a method for synchronization of UGC master and backup data according to one embodiment of the present disclosure.

FIG. 5 is a structural schematic diagram illustrating a system for synchronization of UGC master and backup data according to one embodiment of the present disclosure.

FIG. 6 is a schematic block diagram showing an example of operation environment in which the present disclosure is implemented.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

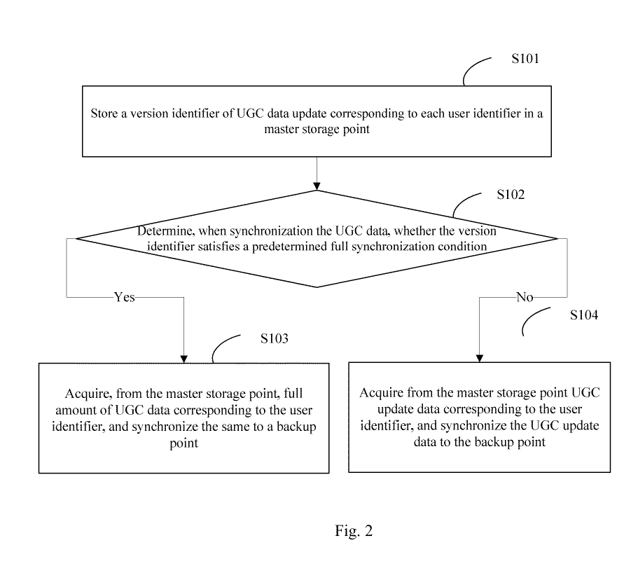

FIG. 2 is a flowchart illustrating a first example of a method for synchronization of UGC master and backup data according to one embodiment of the present disclosure.

The method for synchronization of UGC master and backup data includes the following steps:

S101: storing a version identifier of UGC data update corresponding to each user identifier in a master storage site.

S102: determining, when data synchronization of a master storage site and a backup site of UGC data is executed, whether a version identifier stored satisfies a predetermined full synchronization condition;

performing step S103 to acquire from the master storage site full amount of UGC data corresponding to the user identifier and synchronize the UGC data to the backup site, when it is determined that the version identifier stored satisfies the predetermined full synchronization condition;

otherwise, performing step S104 to acquire from the master storage site the UGC update data corresponding to the user identifier and synchronize the UGC update data to the backup site.

For step S101, the version identifier of UGC data update corresponding to each user identifier in the master storage site, which is used to record data version or cumulative number of updates to UGC data corresponding to the same user identifier, includes version number, or cumulative number of updates to UGC data corresponding to each user identifier. When the UGC data corresponding to each user identifier is updated, the corresponding version identifier is modified. For example, the value of the version is added by 1 each time the UGC data is updated, thereby determining whether to perform full synchronization in step S102 according to the version identifier.

For step S102, synchronization operation of the UGC master and backup data may be performed at predetermined time intervals, or according to other custom trigger modes. Preferably, several user groups are stored both in the master storage site and the backup site, and a user group version identifier of UGC data update is set to each user group, wherein each user group includes a plurality of user identifiers.

Before step S102 is performed, whether to perform data synchronization of the master storage and backup site of UGC data is determined in the following way:

comparing, at predetermined detection time intervals, the value of the version identifier of user group of the master storage site and the value of the version identifier of user group of the backup site to determine whether the version identifier of user group of the master storage site is greater than the version identifier of user group of the backup site; performing, when it is determined that the version identifier of user group of the master storage site is greater than the version identifier of user group of the backup, data synchronization of the master storage site and the backup site of UGC data; otherwise, not performing data synchronization of the master storage site and the backup site of UGC data.

By dividing the multiple user identifiers of the master storage site and the backup site into several user groups, and setting a version identifier for each user group which marks the version of UGC data update of each user group, data synchronization of the master storage site and the backup site of UGC data is performed when the user group version identifier of the master storage site is greater than the user group version identifier of the backup site, which indicates that the UGC data of the master storage site is newer than the UGC data of the backup site.

When performing synchronization of the UGC master and backup data, it is determined that whether the version identifier satisfies the predetermined full synchronization condition. The predetermined condition includes: cumulative number of updates is multiple of a predetermined interval for full synchronization, or the time since last full synchronization of UGC data has exceeded a predetermined value etc., which can be set by those skilled in the art according to actual conditions.

In one embodiment, the step of determining whether the version identifier satisfies the predetermined full synchronization condition may be in the following way:

determining, according to the version identifier, whether the number of updates of the UGC data corresponding to a user identifier after the last full synchronization is greater than or equal to a predetermined full synchronization interval;

if yes, then determine that the version identifier satisfies the predetermined full synchronization condition;

otherwise, determine that the version identifier does not satisfy the predetermined full synchronization condition;

wherein, the full synchronization refers to the synchronization of the full amount of UGC data corresponding to the user identifier to the backup site.

In the present embodiment, the condition of UGC data full synchronization is that whether the number of updates of UGC data is greater than or equal to the predetermined full synchronization interval. For example, the full synchronization interval may be set as 10. After one full synchronization, the UGC data corresponding to a same user identifier will be fully synchronized again only after being updated for 10 times (including adding, deleting and modifying, etc.), when the full synchronization condition is satisfied. Instead, when the full synchronization condition is not satisfied, only incremental synchronization is executed, thereby reducing the occupancy of synchronization data to communication bandwidth resources is reduced.

In the above embodiments, the version identifier is set as the cumulative number of updates of UGC data corresponding to each user identifier. The full synchronization will be performed only when the difference obtained by subtracting the version identifier of last synchronization from the version identifier of this synchronization is greater than or equal to the predetermined full synchronization interval numbers.

For step S103, the full amount of UGC data corresponding to the version identifier includes UGC update data and UGC history data corresponding to the user identifier.

For step S104, only the UGC update data corresponding to the user identifier is synchronized.

In the method for synchronization of UGC master and backup data of the present disclosure, by the version identifier of UGC data update corresponding to each user identifier stored in the master storage site and the predetermined full synchronization condition, the full synchronization will be performed only when the version identifier satisfies the predetermined full synchronization condition; otherwise, incremental synchronization is performed, such that the synchronous data will not occupy excessive communication bandwidth resources. Thus, real-time consistency of expansive data of UGC application can be maintained even under the narrowband circumstances.

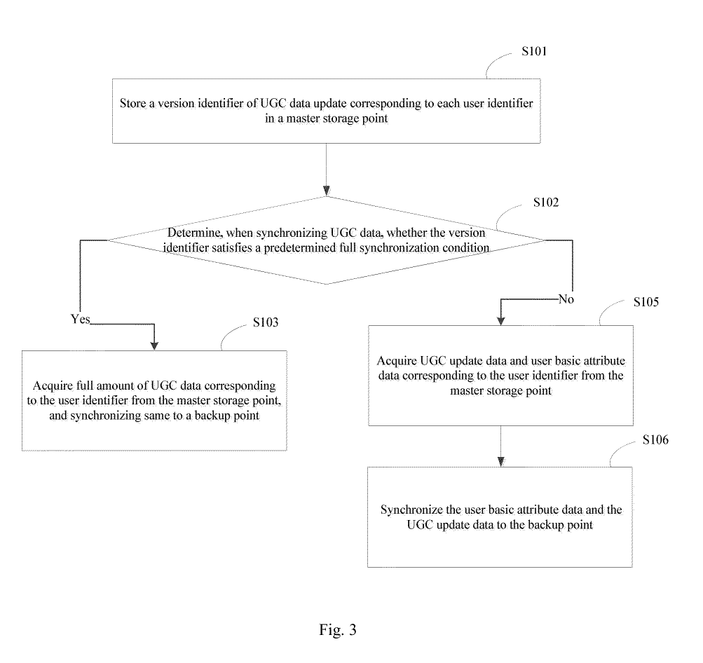

FIG. 3 is a flowchart illustrating a second example of a method for synchronization of UGC master and backup data according to one embodiment of the present disclosure.

The main difference between methods of the second example and the first example lies in the following aspect.

After performing step S102, the following steps are further performed when the version identifier does not satisfy the predetermined full synchronization condition:

step S105: acquiring a user basic attribute data corresponding to the user identifier;

then, synchronizing the user basic attribute data and the UGC update data to the backup site in step S106.

The UGC data corresponding to a user identifier can be divided into user basic attribute data, and appended data generated by the user in one operation.

The appended data, as the main source of UGC data expansion, is generated by the user in one operation. It may by newly-added data generated by a user's one time operation of uploading or editing; in a micro-blog system, for example, the appended data may be the content, publishing time and resource of a message published by user, and the publisher's ID.

The user basic attribute data is the UGC data other than the appended data. Typically, it is the basic statistical data of an UGC application system, or it is the UGC data that is not generated by a user in a single application. For example, in a micro-blog system, the user basic attribute data may include statistical data such as the number micro-blogs originally published by a user, the number micro-blogs forwarded by a user, the number of comments, and the user score. It is characterized in that is the amount of data is not big, and will grow dramatically as time goes by. Typically, the appended data is far greater than the user basic attribute data.

In the present embodiments, when it is determined that the version identifier does not satisfy the predetermined full synchronization condition, not only the UGC update data corresponding to the user identifier will be synchronized, but also the user basic attribute data corresponding to the user identifier will be synchronized. Thus, the consistency between the user basic attribute data in the backup site and master storage site can be maintained. On the other hand, as the appended data generated by the user's operation is the main source of UGC data expansion, the user basic attribute data has a relatively small amount and may not likely to expand much over time. Thus, synchronization of the user basic attribute data will not occupy excessive communication bandwidth resources, and by the synchronization it better solves the problem of consistency of UGC master and backup data.

Preferably, the method for synchronization of UGC master and backup data of the present disclosure further includes, before determining whether the version identifier satisfies the predetermined full synchronization condition, the following steps:

reading the UGC update log of the master storage site, and acquiring a user identifier corresponding to UGC data update recorded in the UGC update log;

acquiring the version identifier of the UGC data update corresponding to the user identifier, and determining.

When performing the synchronization of UGC master and backup data, firstly, select the user identifier of which the corresponding UGC data has been updated; then, acquire the version identifier of UGC update data according to the selected user identifier; and, determine whether the predetermined full synchronization condition is satisfied. The synchronization efficiency is enhanced by selecting in advance the user identifier of which the corresponding UGC data has been updated.

Furthermore, each time when synchronizing the full amount of UGC data or the UGC update data to the backup site, the version identifier of UGC data update corresponding to the user identifier is stored as a history version identifier.

As a result, the step of acquiring from the master storage site the UGC update data corresponding to the user identifier may include:

acquiring, from the UGC update log in the master storage site and according to current version identifier of the UGC data update and the history version identifier corresponding to the user identifier, the UGC update data corresponding to the user identifier.

By comparing the current version identifier and the history version identifier, it can be accurately determined what updates has occurred to the UGC data after the last synchronization, such that the corresponding UGC update data can be conveniently acquired from the UGC update log.

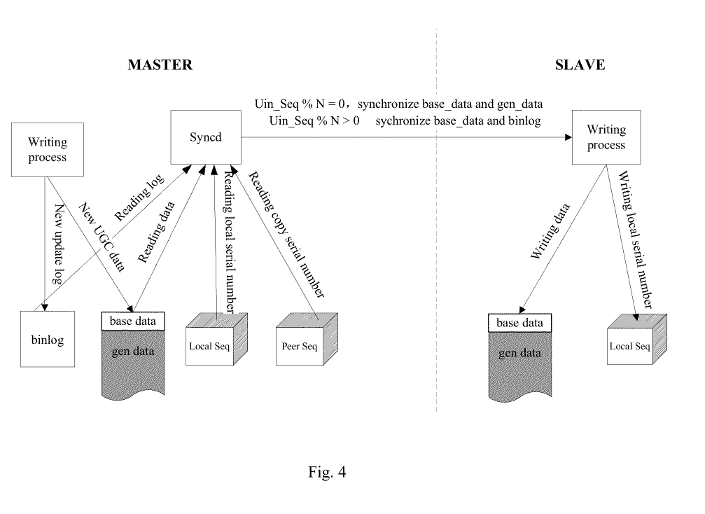

FIG. 4 is a schematic diagram illustrating an application of a method for synchronization of UGC master and backup data according to one embodiment of the present disclosure.

Taking the synchronization of UGC master and backup data in a micro-blog system for example, the UGC data of the micro-blog system is divided into the user basic attribute data ‘base_data’, and the appended data ‘gen_data’ generated by user in a single operation. The version identifier of UGC data update corresponding to each user identifier ‘uin’ in the master storage site ‘Master’ is stored as a serial number of UGC data update, ‘uin seq’. When the UGC data is updated, the uin seq will be added by 1 no matter it is the base_data or the gen_data that has been changed.

The user identifier ‘Uin’ in the master storage site and backup site is divided into several user groups ‘unit’, and each user group ‘unit’ includes a plurality of the user identifiers ‘Uin’. For example, 100,000 successive Uins are a Unit. A version identifier ‘local seq’ of a user group of UGC data update is set for each user group in the master storage site, and the user group version identifier ‘local seq’ of UGC data update set for each user group in the backup site is recorded in the master storage site.

The synchronization process ‘syncd’ periodically check the ‘local seq’ and ‘peer seq’ of each user group. When it is determined that local seq>peer seq, the synchronization is initiated.

There are two modes of data synchronization: incremental synchronization and full synchronization. The condition for full synchronization is set as Uin_Seq % N=0, where ‘%’ is a modulus operator, and ‘N’ is predetermined frequency factor of full synchronization, its value being positive integers within the range of [1,+∞]. Thus, the value of ‘Uin_Seq % N’ is in a range of [0, N−1]. When Uin_Seq % N=0, then synchronize the full amount of UGC data of the corresponding uin; that is, base_data is added by gen_data. When Uin_Seq % N>0, synchronize the user basic attribute data ‘base_data’ of the corresponding uin and UGC update data ‘binlog’. For example, assuming the value of N is 10, among every ten updates, nine of them are incremental data synchronization and one is full data synchronization. The consistency of UGC master and backup data is maintained thereby, while the occupancy to the communication bandwidth resources is reduced.

The method for synchronization of UGC master and backup data in the present embodiment has following advantages. It can ensure, for continuously expanding UGC data, substantially the same synchronization efficiency to synchronization of normal data while maintaining data consistency in real-time. This can solve the problem of high consumption of bandwidth occupied by the continuously expanding UGC data, enabling data synchronization in narrowband and thereby saving cost. In addition, it can realize flexible synchronization configuration by conveniently adjusting the respective proportion of full synchronization and incremental synchronization by setting the frequency factor N of full synchronization, making the system operation more flexible.

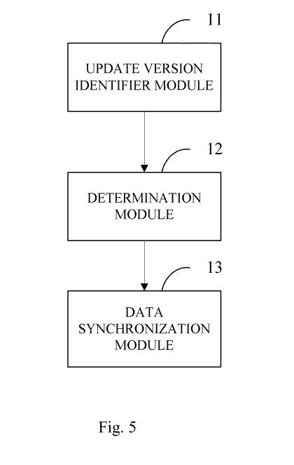

FIG. 5 is a structural schematic diagram illustrating a system for synchronization of UGC master and backup data according to one embodiment of the present disclosure.

The system for synchronization of UGC master and backup data includes an update version identifier module 11, a determination module 12 and a data synchronization module 13. The version identifier updating module 11 is configured to store a version identifier of UGC data update corresponding to each user identifier in a master storage site. The determination module 12 is configured to determine, when performing data synchronization of the master storage site and backup site of UGC data, whether the version identifier satisfies a predetermined full synchronization condition. The data synchronization module 13 is configured to acquire from the master storage site full amount of UGC data corresponding to the user identifier and synchronize the full amount of UGC data to the backup site when the version identifier satisfies the predetermined full synchronization condition, and to acquire UGC update data corresponding to the user identifier from the master storage site and synchronize the UGC update data to the backup site when the version identifier does not satisfy the predetermined full synchronization condition.

The version identifier of UGC data update corresponding to each user identifier in the master storage site, which is used to record data version or cumulative number of updates to UGC data corresponding to the same user identifier, includes version number, or cumulative number of updates to UGC data corresponding to each user identifier. When the UGC data corresponding to each user identifier is updated, the corresponding version identifier is modified. For example, the value of the version is added by 1 each time the UGC data is updated. The determination module 12 is configured to determine whether to perform full synchronization based on the version identifier.

The synchronization operation of the UGC master and backup data may be performed at predetermined time intervals, or according to other custom trigger modes.

Preferably, the system for synchronization of UGC master and backup data further includes a user group setting module and an update determination module (not shown). The user group setting module is configured to store several user groups both in the master storage site and the backup site, and set, for each user group, a version identifier of UGC data update of the user group, wherein each user group includes a plurality of user identifiers.

The update determination module is configured to determine in the following way, before it is determined by the determination module 12 that whether the version identifier satisfies the predetermined full synchronization condition, whether to perform data synchronization of the master storage and backup site of UGC data:

comparing, at predetermined detection time intervals, the value of the version identifier of user group of the master storage site and the value of the version identifier of user group of the backup site to determine whether the version identifier of user group of the master storage site is greater than the version identifier of user group of the backup site; performing, when it is determined that the version identifier of user group of the master storage site is greater than the version identifier of user group of the backup, data synchronization of the master storage site and the backup site of UGC data; otherwise, not performing data synchronization of the master storage site and the backup site of UGC data.

By dividing the user identifiers of the master storage site and the backup site into several user groups, and setting a version identifier for each user group which marks the version of UGC data update of each user group, the efficiency of data synchronization is enhanced. Data synchronization of the master storage site and the backup site of UGC data is performed when the user group version identifier of the master storage site is greater than the user group version identifier of the backup site, which indicates that the UGC data of the master storage site is newer than the UGC data of the backup site.

When performing synchronization of the UGC master and backup data, the determination module 12 may determine that whether the version identifier satisfies the predetermined full synchronization condition. The predetermined condition includes: cumulative number of updates is multiple of a predetermined interval for full synchronization, or the time since last full synchronization of UGC data has exceeded a predetermined value etc., which can be set by those skilled in the art according to actual conditions.

As one embodiment, the determining of whether the version identifier satisfies the predetermined full synchronization condition by the determination module 12 may be in the following way:

determining, according to the version identifier, whether the number of updates of the UGC data corresponding to a user identifier after the last full synchronization is greater than or equal to a predetermined full synchronization interval;

if yes, then determine that the version identifier satisfies the predetermined full synchronization condition;

otherwise, determine that the version identifier does not satisfy the predetermined full synchronization condition;

wherein, the full synchronization is the synchronization of the full amount of UGC data corresponding to the user identifier to the backup site.

In the present embodiment, whether the number of updates of UGC data is greater than or equal to the predetermined full synchronization interval is set as the condition of UGC data full synchronization by the determination module 12. For example, the full synchronization interval may be set as 10. After one full synchronization, the UGC data corresponding to a same user identifier will be fully synchronized again only after being updated for 10 times (including adding, deleting and modifying, etc.), when the full synchronization condition is satisfied. Instead, when the full synchronization condition is not satisfied, only incremental synchronization is executed, thereby reducing the occupancy of synchronization data to communication bandwidth resources is reduced.

In the above embodiments, the version identifier is set as the cumulative number of updates of UGC data corresponding to each user identifier. The full synchronization will be performed only when the difference obtained by subtracting the version identifier of last synchronization from the version identifier of this synchronization is determined by the determination module 12 as being greater than or equal to the predetermined full synchronization interval numbers.

The full amount of UGC data corresponding to the version identifier includes UGC update data and UGC history data corresponding to the user identifier. The data synchronization module 13 is configured to perform respectively the full synchronization and the incremental synchronization based on the determination of the determination module 12. When performing the full synchronization, the full amount of UGC data (including UGC update data and UGC history data) corresponding to the user identifier is synchronized to the backup site. When performing the incremental synchronization, the UGC update data corresponding to the user identifier is synchronized to the backup site.

In the method for synchronization of UGC master and backup data of the present disclosure, by the version identifier of UGC data update corresponding to each user identifier stored in the master storage site and the predetermined full synchronization condition, the full synchronization will be performed only when the version identifier satisfies the predetermined full synchronization condition; otherwise, incremental synchronization is performed, such that the synchronous data will not occupy excessive communication bandwidth resources. Thus, real-time consistency of expansive data of UGC application can be maintained even under the narrowband circumstances.

In a preferable example of the system for synchronization of UGC master and backup data, when the version identifier dose not satisfy the predetermined full synchronization condition, the data synchronization module 13 is further configured to acquire user basic attribute data corresponding to the user identifier and synchronize the user basic attribute data and the UGC update data to the backup site.

The UGC data corresponding to a user identifier can be divided into user basic attribute data, and appended data generated by the user in one operation.

The appended data, as the main source of UGC data expansion, is generated by the user in one operation. It may by newly-added data generated by a user's one time operation of uploading or editing; in a micro-blog system, for example, the appended data may be the content, publishing time and resource of a message published by user, and the publisher's ID.

The user basic attribute data is the UGC data other than the appended data. Typically, it is the basic statistical data of an UGC application system, or it is the UGC data that is not generated by a user in a single application. For example, in a micro-blog system, the user basic attribute data may include statistical data such as the number micro-blogs originally published by a user, the number micro-blogs forwarded by a user, the number of comments, and the user score. It is characterized in that is the amount of data is not big, and will grow dramatically as time goes by. Typically, the appended data is far greater than the user basic attribute data.

In the present embodiments, when it is determined by the determination module 12 that the version identifier does not satisfy the predetermined full synchronization condition, the data synchronization module 13 will not only synchronize the UGC update data corresponding to the user identifier, but also synchronize the user basic attribute data corresponding to the user identifier. Thus, the consistency between the user basic attribute data in the backup site and master storage site can be maintained. On the other hand, as the appended data generated by the user's operation is the main source of UGC data expansion, the user basic attribute data has a relatively small amount and may not likely to expand much over time. Thus, synchronization of the user basic attribute data will not occupy excessive communication bandwidth resources, and by the synchronization it better solves the problem of consistency of UGC master and backup data.

Preferably, the determination module 12 is further configured to read UGC update log of the master storage site, and acquire a user identifier corresponding to UGC data update recorded in the UGC update log; and, acquire the version identifier of the UGC data update corresponding to the user identifier to determine

When performing the synchronization of UGC master and backup data, the determination will firstly select the user identifier of which the corresponding UGC data has been updated, and then acquire the version identifier of UGC update data according to the selected user identifier to determine whether the predetermined full synchronization condition is satisfied. The synchronization efficiency is enhanced by selecting in advance the user identifier of which the corresponding UGC data has been updated.

Furthermore, the data synchronization module 13 is further configured to, each time when synchronizing the full amount of UGC data or the UGC update data to the backup site, store the version identifier of UGC data update corresponding to the user identifier as a history version identifier and, acquire the UGC update data corresponding to the user identifier from the UGC update log in the master storage site according to current version identifier of the UGC data update and the history version identifier corresponding to the user identifier.

By comparing the current version identifier and the history version identifier, it can be accurately determined what updates has occurred to the UGC data after the last synchronization, such that the corresponding UGC update data can be conveniently acquired from the UGC update log.

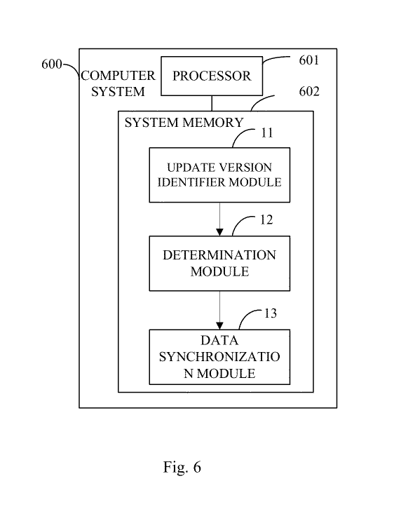

FIG. 6 is a schematic block diagram showing an operation environment in which the above embodiments can be implemented. A computer system 600 is configured to perform synchronization of UGC master and backup data for one or more software entities. As shown in FIG. 6, the computer system 600 includes processor 601 and system memory 602.

The computer system 600 is intended to broadly represent any system that is based on a processor, based on which software can be executed for the benefits of user.

The processor 601 includes one or more processors or processor cores which are configured to execute a software module and access data in the system memory 602. The software module stored in the system memory 602 at least includes an update version identifier module 11, a determination module 12 and a data synchronization module 13. The system memory 602 is intended to broadly represent any types of memories, which can store a software module and the data to be executed and accessed by the processor 601. In one embodiment, the system memory 602 includes a non-volatile memory, such as random access memory (RAM).

It should be noted that for a person skilled in the art, partial or full process to realize the methods in the above embodiments can be accomplished by related hardware instructed by a computer program; the program can be stored in a computer readable storage medium and the program can include the process of the embodiments of the above methods. The storage medium can be a disk, a light disk, a Read-Only Memory or a Random Access Memory, etc.

The embodiments are chosen and described in order to explain the principles of the disclosure and their practical application so as to allow others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for synchronization of UGC master and backup data, comprising:
determining, when performing data synchronization of a master storage site and a backup site of UGC data, whether a version identifier stored satisfies a predetermined full synchronization condition, the version identifier corresponding to UGC data update of each user identifier in the master storage site;
acquiring, when it is determined that the version identifier stored satisfies the predetermined full synchronization condition, from the master storage site full amount of UGC data corresponding to the user identifier, and synchronizing the UGC data to the backup site;
otherwise, acquiring from the master storage site the UGC update data corresponding to the user identifier, and synchronizing the UGC update data to the backup site.

2. The method of claim 1, further comprising, when the version identifier does not satisfy the predetermined full synchronization condition, the steps of:
acquiring user basic attribute data corresponding to the user identifier;
synchronizing the user basic attribute data and the UGC update data to the backup site.

3. The method of claim 1, further comprising, before determining whether the version identifier satisfies the predetermined full synchronization condition, the step of:
reading UGC update log in the master storage site, and acquiring a user identifier corresponding to UGC data update recorded in the UGC update log;
acquiring the version identifier of the UGC data update corresponding to the user identifier, and determining.

4. The method of claim 3, wherein each time when synchronizing the full amount of UGC data or the UGC update data to the backup site, the version identifier of UGC data update corresponding to the user identifier is stored as a history version identifier; and
the step of acquiring from the master storage site the UGC update data corresponding to the user identifier comprises:
acquiring, from the UGC update log in the master storage site and according to current version identifier of the UGC data update and the history version identifier corresponding to the user identifier, the UGC update data corresponding to the user identifier.

5. The method of claim 1, wherein determining whether the version identifier satisfies the predetermined full synchronization condition comprises:
determining, according to the version identifier, whether the number of updates of the UGC data corresponding to a user identifier after the last full synchronization is greater than or equal to a predetermined full synchronization interval;
if yes, then determine that the version identifier satisfies the predetermined full synchronization condition;
otherwise, determine that the version identifier does not satisfy the predetermined full synchronization condition;
wherein the full synchronization refers to the synchronization of the full amount of UGC data corresponding to the user identifier to the backup site.

6. The method of claim 5, wherein the version identifier is the cumulative number of updates of UGC data corresponding to each user identifier.

7. The method of claim 1, wherein several user groups are stored both in the master storage site and the backup site, a user group version identifier of UGC data update is set to each user group, and wherein, each user group includes a multiple of the version identifiers;
when performing data synchronization, the method further comprises, before determining whether the version identifier satisfies the predetermined full synchronization condition, the step of determining whether to perform data synchronization of the master storage site and the backup site of UGC data in the following way:
comparing, at predetermined detection time intervals, the value of the version identifier of user group of the master storage site and the value of the version identifier of user group of the backup site to determine whether the version identifier of user group of the master storage site is greater than the version identifier of user group of the backup site;
performing, when it is determined that the version identifier of user group of the master storage site is greater than the version identifier of user group of the backup, data synchronization of the master storage site and the backup site of UGC data;
otherwise, not performing data synchronization of the master storage site and the backup site of UGC data.

8. A system for synchronization of UGC master and backup data, executing in a computer system comprising a processor and a system memory, the system memory comprising:
an update version identifier module, configured to store a version identifier of UGC data update corresponding to each user identifier in a master storage site;
a determination module, configured to determine, when data synchronization of the master storage site and backup site of UGC data is executed, whether the version identifier satisfies a predetermined full synchronization condition, and
a data synchronization module, configured to acquire from the master storage site full amount of UGC data corresponding to the user identifier and synchronize the full amount of UGC data to the backup site when the version identifier satisfies the predetermined full synchronization condition, and to acquire UGC update data corresponding to the user identifier from the master storage site and synchronize the UGC update data to the backup site when the version identifier does not satisfy the predetermined full synchronization condition.

9. The system of claim 8, wherein the data synchronization module is further configured to, when the version identifier does not satisfy the predetermined full synchronization condition, acquire user basic attribute data corresponding to the user identifier, and synchronize the user basic attribute data and the UGC update data to the backup site.

10. The system of claim 8, wherein the determination module is further configured to read UGC update log of the master storage site, acquire a user identifier corresponding to the UGC data update recorded in the UGC update log, and acquire the version identifier of the UGC data update corresponding to the user identifier to determine.

11. The system of claim 10, wherein the data synchronization module is further configured to, each time when synchronizing the full amount of UGC data or the UGC update data to the backup site, store the version identifier of UGC data update corresponding to the user identifier as a history version identifier; and acquire the UGC update data corresponding to the user identifier from the UGC update log in the master storage site according to current version identifier of the UGC data update and the history version identifier corresponding to the user identifier.

12. The system of claim 8, wherein the determination module is further configured to determine, according to the version identifier, whether the number of updates of the UGC data corresponding to a user identifier after the last full synchronization is greater than or equal to a predetermined full synchronization interval; if yes, then determine that the version identifier satisfies the predetermined full synchronization condition; otherwise, determine that the version identifier does not satisfy the predetermined full synchronization condition; wherein the full synchronization being the synchronization of the full amount of UGC data corresponding to the user identifier to the backup site.

13. The system of claim 12, wherein the version identifier is the cumulative number of updates of UGC data corresponding to each user identifier.

14. The system of claim 8, further comprising:
a user group setting module, configured to store several user groups both in the master storage site and the backup site, and set, for each user group, a version identifier of UGC data update of the user group, wherein each user group comprising a plurality of user identifiers;
an update determination module, configured to determine in the following way, before it is determined by the determination module that whether the version identifier satisfies the predetermined full synchronization condition, whether to perform data synchronization of the master storage and backup site of UGC data:
comparing, at predetermined detection time intervals, the value of the version identifier of user group of the master storage site and the value of the version identifier of user group of the backup site to determine whether the version identifier of user group of the master storage site is greater than the version identifier of user group of the backup site; performing, when it is determined that the version identifier of user group of the master storage site is greater than the version identifier of user group of the backup, data synchronization of the master storage site and the backup site of UGC data; otherwise, not performing data synchronization of the master storage site and the backup site of UGC data.

15. A non-transitory computer-readable storage medium storing computer-executable instructions which, when executed by one or more computer processors, cause the one or more computer processors to perform a method for synchronization of UGC master and backup data, the method comprising:
determining, when performing data synchronization of a master storage site and a backup site of UGC data, whether a version identifier stored satisfies a predetermined full synchronization condition, the version identifier corresponding to update of UGC data of each user identifier in the master storage site;
acquiring, when it is determined that the version identifier stored satisfies the predetermined full synchronization condition, from the master storage site full amount of UGC data corresponding to the user identifier, and synchronizing the UGC data to the backup site;
otherwise, acquiring from the master storage site the UGC update data corresponding to the user identifier, and synchronizing the UGC update data to the backup site.

16. The non-transitory computer-readable storage medium of claim 15, wherein the method further comprises, when the version identifier does not satisfy the predetermined full synchronization condition, the steps of:
acquiring user basic attribute data corresponding to the user identifier;
synchronizing the user basic attribute data and the UGC update data to the backup site.

17. The non-transitory computer-readable storage medium of claim 15, wherein the method further comprises, before determining whether the version identifier satisfies the predetermined full synchronization condition, the step of:
reading UGC update log in the master storage site, and acquiring a user identifier corresponding to UGC data update recorded in the UGC update log;
acquiring the version identifier of the UGC data update corresponding to the user identifier, and determining.

18. The non-transitory computer-readable storage medium of claim 17, wherein each time when synchronizing the full amount of UGC data or the UGC update data to the backup site, the version identifier of UGC data update corresponding to the user identifier is stored as a history version identifier; and
the step of acquiring from the master storage site the UGC update data corresponding to the user identifier comprises:
acquiring, from the UGC update log in the master storage site and according to current version identifier of the UGC data update and the history version identifier corresponding to the user identifier, the UGC update data corresponding to the user identifier.

19. The non-transitory computer-readable storage medium of claim 15, wherein determining whether the version identifier satisfies the predetermined full synchronization condition comprises:
determining, according to the version identifier, whether the number of updates of the UGC data corresponding to a user identifier after the last full synchronization is greater than or equal to a predetermined full synchronization interval;
if yes, then determine that the version identifier satisfies the predetermined full synchronization condition;
otherwise, determine that the version identifier does not satisfy the predetermined full synchronization condition;
wherein the full synchronization refers to the synchronization of the full amount of UGC data corresponding to the user identifier to the backup site.

20. The non-transitory computer-readable storage medium of claim 19, wherein the version identifier is the cumulative number of updates of UGC data corresponding to each user identifier.
